(19) United States
(12) Patent Application Publication
(10) Pub. No.: US 2008/0306741 A1
(43) Pub. Date: Dec. 11, 2008

(54) ROBOT AND METHOD FOR ESTABLISHING A RELATIONSHIP BETWEEN INPUT COMMANDS AND OUTPUT REACTIONS

(75) Inventors: Han-Che Wang, Shenzhen City (CN); Tsu-Li Chiang, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/972,628

(22) Filed: Jan. 11, 2008

(30) Foreign Application Priority Data
Jun. 8, 2007 (CN) 200710074771.5

(51) Int. Cl. G10L 15/22

(52) U.S. Cl. 704/275; 704/E15.04

(57) ABSTRACT

The present invention relates to a robot and method for establishing a relationship between input commands and output reactions. When initiating an input configuration program, the robot fetches a predetermined motion output reaction and performs a corresponding motion. At this time, the robot receives a vocal input command from a user to obtain a vocal input profile, and establishes a relationship between the motion output reaction and the vocal input profile. When receiving the vocal input command again, the robot performs the corresponding motion according to the relationship. In addition, a sound assigned to the motion output reaction can be altered according to users' preferences. Accordingly, the motion output reaction may have different naming sound.

### BACKGROUND OF THE INVENTION

1. Field of the Invention

The present invention relates to robots, and particularly, to a robot and method capable of establishing a relationship between a vocal input command and a motion output reaction.

2. General Background

There are many robotic design in the market today. Robots may be designed to perform tedious manufacturing tasks or for entertainment. Robots are generally equipped with a database to store vocal commands and motion reactions. When receiving sound generated from a user, the robot identifies the sound to obtain a vocal profile of the sound, searches its database to find a motion reaction corresponding to the vocal profile, and exports the motion reaction to perform a particular motion. Unfortunately, when the database does not store the vocal profile or the corresponding motion reaction, the robot has no response to the sound of the user, and thus will not respond or may try to respond and may malfunction.

In addition, the database generally stores limited vocal profiles and the corresponding motion reactions. As a result, the usage of the robot is limited.

Accordingly, what is needed in the art is a robot that overcomes the deficiencies of the prior art.

### SUMMARY OF THE INVENTION

A robot for establishing a relationship between input commands and output reactions is provided. The robot includes a startup unit, for generating a triggering signal; a microphone, for receiving a vocal input command from a user and transforming the vocal input command into an analog vocal signal; an A/D converter, for converting the analog vocal signal into a digital vocal signal; an actuator, for performing a motion; a storage unit, for storing a set of predetermined motion output reactions; and a processing unit, for fetching a motion output reaction from the storage unit to control the actuator to perform a corresponding motion when receiving the triggering signal generated from the startup unit, for obtaining a vocal input profile from the user and storing the vocal input profile in the storage unit, and for establishing a relationship between the motion output reaction and the vocal input profile and storing the relationship in the storage unit.

A method adapted for a robot is provided. Wherein the robot stores a set of predetermined motion output reactions, the method includes the steps of: (a) initiate an input configuration program; (b) fetching a motion output reaction and performing a corresponding motion; (c) generating prompt information; (d) receiving a vocal input command from a user; (e) analyzing a digital vocal signal of the vocal input to obtain a vocal input profile, and storing the vocal input profile; and (f) establishing a relationship between the motion output reaction and the vocal input profile, and storing the relationship.

Other advantages and novel features will be drawn from the following detailed description with reference to the attached drawing.

### BRIEF DESCRIPTION OF THE DRAWINGS

The components in the drawings are not necessarily drawn to measuring scale, the emphasis instead being placed upon clearly illustrating the principles of the robot. Moreover, in the drawings, like reference numerals designate corresponding parts throughout the several views.

FIG. 1 is a block diagram of a hardware infrastructure of a robot of the invention.

FIG. 2 is a flow chart illustrating an input configuration program which is performed by the robot of FIG. 1.

FIG. 3 is a flow chart illustrating a review process which is performed by the robot of FIG. 1.

### DETAILED DESCRIPTION OF THE INVENTION

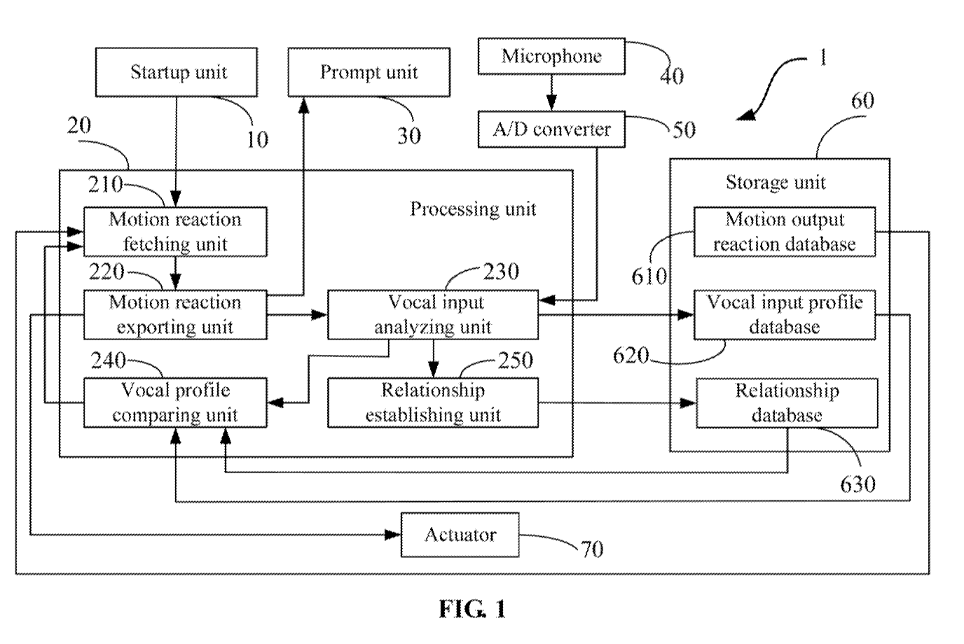

FIG. 1 is a block diagram of a hardware infrastructure of a robot. The robot 1 includes a startup unit 10, a prompt unit 30, a microphone 40, an analog-digital (A/D) converter 50, a processing unit 20, a storage unit 60, and an actuator 70. The startup unit 10 is configured for generating a triggering signal to initiate an input configuration program of the robot 1. The startup unit 10 may be a microphone 40, a button, or other input unit. The startup unit 10 may be located on a part of a body of the robot 1, such as a head of the robot 1. The prompt unit 30 is configured for generating prompt information for prompting a user to utter a vocal input command after the actuator 70 performs a motion. The microphone 40 is configured for receiving the vocal input command from the user and transforming the vocal input command into an analog vocal signal. The A/D converter 50 is configured for converting the analog vocal signal into a digital vocal signal. The processing unit 20 is configured for processing the digital vocal signal and controlling the robot 1. The actuator 70 is located in a movable part of the robot 1. The actuator 70 includes a motor and some mechanical movement units. The robot 1 includes a series of actuators 70 to perform a plurality of different motions.

The storage unit 60 stores some databases, for example, a motion output reaction database 610, a vocal input profile database 620, and a relationship database 630. The motion output reaction database 610 stores a set of predetermined motion output reactions. The vocal input profile database 620 stores a set of vocal input profiles from the user. The relationship database 630 stores a set of relationships between the motion output reactions and the vocal input profiles. The storage unit 60 also stores specific information. The specific information may be a specific motion, a specific sound, or a combination of a specific motion and a specific sound.

The processing unit 20 further includes a motion reaction fetching unit 210, a motion reaction exporting unit 220, a vocal input analyzing unit 230, a vocal profile comparing unit 240, and a relationship establishing unit 250. The motion reaction fetching unit 210 is configured for fetching a motion output reaction from the motion output reaction database 610. The motion reaction exporting unit 220 is configured for exporting a motion output reaction and controlling the actuator 70 to perform a corresponding motion and sending an awakening signal to the vocal input analyzing unit 230. The vocal input analyzing unit 230, electrically coupled to the motion reaction exporting unit 220, is configured for analyzing the digital vocal signal from the A/D converter 50, obtaining a vocal input profile, and generating an identification result. The relationship establishing unit 250 is configured for establishing a relationship between the motion output reaction and the vocal input profile.

According to the identification result from the vocal input analyzing unit 230, the vocal profile comparing unit 240 is configured for comparing a vocal input profile with vocal input profiles stored in the vocal input profile database 620, fetching a vocal input profile from the vocal input profile database 620, and fetching a relationship about the vocal input profile associated with a motion output reaction from the relationship database 630.

When the robot 1 receives the triggering signal from the startup unit 10, namely where the robot 1 initiates the input configuration program, the motion reaction fetching unit 210 randomly fetches a motion output reaction from the motion output reaction database 610. The motion reaction exporting unit 220 exports the motion output reaction and controls the actuator 70 to perform a corresponding motion. The motion reaction exporting unit 220 also invokes the prompt unit 30 to generate the prompt information for the user. The prompt information may be in a form of sound, light and so on. The microphone 40 receives the vocal input command from the user and transforms the vocal input command into an analog vocal signal. The A/D converter 50 converts the analog vocal signal into a digital vocal signal. The vocal input analyzing unit 230 analyzes the digital vocal signal to obtain a vocal input profile, and stores the vocal input profile in the vocal input profile database 620 according to the awakening signal from the motion reaction exporting unit 220. The relationship establishing unit 250 establishes a relationship between the motion output reaction and the vocal input profile, and stores the relationship in the relationship database 630, thereby achieving the input configuration program.

When the microphone 40 receives a vocal input command from the user, and the robot 1 is out of the input configuration program, the microphone 40 transforms the vocal input command into an analog vocal signal and the A/D converter 50 converts the analog vocal signal into a digital vocal signal. The vocal input analyzing unit 230 analyzes the digital vocal signal to obtain a vocal input profile. The vocal profile comparing unit 240 compares the vocal input profile with stored vocal input profiles from the vocal input profile database 620 according to the identification result from the vocal input analyzing unit 230. If the relationship database 630 exists for a corresponding relationship for the vocal input profile, the vocal profile comparing unit 240 fetches the corresponding relationship. The motion reaction fetching unit 210 fetches a motion output reaction from the motion output reaction database 610 according to the corresponding relationship. The motion reaction exporting unit 220 controls the actuator 70 to perform a corresponding motion. If the relationship database 630 does not exist for the corresponding relationship, the motion reaction exporting unit 220 controls the actuator 70 to perform the specific information.

The robot 1 is equipped with a reset button (not shown) on an external surface. When the reset button is pressed, the robot 1 establishes a new relationship between a motion output reaction and a vocal input profile from the user in the relationship database 630.

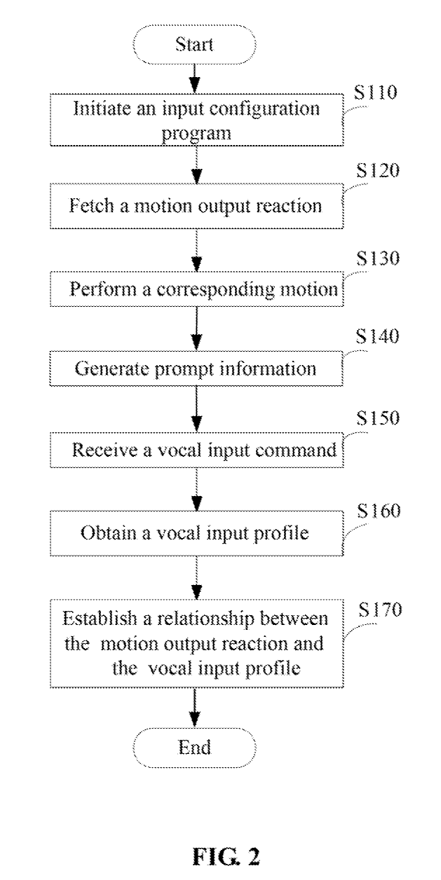

FIG. 2 is a flow chart illustrating an input configuration program which is performed by the robot of FIG. 1. In step S110, the processing unit 20 initiates the input configuration program according to the triggering signal generated from the startup unit 10. In step S120, the motion reaction fetching unit 210 fetches a motion output reaction from the motion output reaction database 610 to the motion reaction exporting unit 220. In step S130, the motion reaction exporting unit 220 exports the motion output reaction and controls the actuator 70 to perform a corresponding motion. In step S140, the motion reaction exporting unit 220 also invokes the prompt unit 30 to generate the prompt information for the user and sends an awakening signal to the vocal input analyzing unit 230. In step S150, the microphone 40 receives a vocal input command from the user and transforms the vocal input command into an analog vocal signal. The A/D converter 50 converts the analog vocal signal into the digital vocal signal, and transmits the digital vocal signal to the processing unit 20.

In step S160, the vocal input analyzing unit 230 analyzes the digital vocal signal to obtain a vocal input profile, and stores the vocal input profile to the vocal input profile database 620 according to the awakening signal. In step S170, the relationship establishing unit 250 establishes a corresponding relationship between the motion output reaction and the vocal input profile, and stores the corresponding relationship to the relationship database 630.

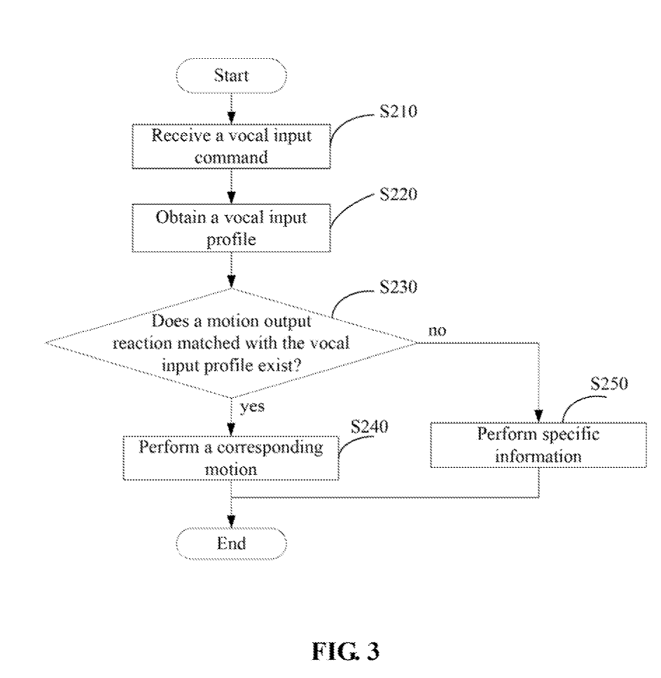

FIG. 3 is a flow chart illustrating a review process which is performed by the robot of FIG. 1. In step S210, when the robot 1 is out of the input configuration program, meaning that the prompt unit 30 doesn't generate the prompt information, the microphone 40 receives a vocal input command from the user and transforms the vocal input command into an analog vocal signal. In step S220, the A/D converter 50 converts the analog vocal signal into a digital vocal signal, and the vocal input analyzing unit 230 analyzes the digital vocal signal to obtain a vocal input profile. In step S230, the vocal profile comparing unit 240 searches for the vocal input profile database 620 to obtain a motion output reaction matched with the vocal input profile. If the vocal input profile database 620 exists for a motion output reaction matched with the vocal input profile, in step S240, the motion reaction exporting unit 220 controls the actuator 70 to perform a corresponding motion according to the motion output reaction. If the vocal input profile database 620 does not exist for the motion output reaction matched with the vocal input profile, in step S250, the motion reaction exporting unit 220 controls the actuator 70 to perform the specific information.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A robot for establishing a relationship between input commands and output reactions, the robot comprising:
a startup unit for generating a triggering signal;
a microphone for receiving a vocal input command from a user and transforming the vocal input command into an analog vocal signal;
an A/D converter for converting the analog vocal signal into a digital vocal signal;
an actuator for performing a motion;
a storage unit for storing a set of predetermined motion output reactions; and
a processing unit, for fetching a motion output reaction from the storage unit to control the actuator to perform a corresponding motion when receiving the triggering signal generated from the startup unit, for obtaining a vocal input profile from the user and storing the vocal input profile in the storage unit, and for establishing a relationship between the motion output reaction and the vocal input profile and storing the relationship in the storage unit.

2. The robot as recited in claim 1, wherein when the microphone receives a vocal input command, and the storage unit stores a relationship between a motion output reaction and a vocal input profile of the vocal input, the processing unit fetches the motion output reaction, and controls the actuator to perform a corresponding motion.

3. The robot as recited in claim 1, wherein the processing unit comprises:
a motion reaction fetching unit, for fetching a motion output reaction from the storage unit;
a motion reaction exporting unit, for exporting a motion output reaction and controlling the actuator to perform a corresponding motion;
a vocal input analyzing unit, for analyzing the digital vocal signal generated from the A/D converter to obtain a vocal input profile; and
a relationship establishing unit, for establishing a relationship between the motion output reaction and the vocal input profile.

4. The robot as recited in claim 1, further comprising a reset button, wherein when receiving a signal generated from the reset button, the processing unit establishes a new relationship between a motion output reaction and a vocal input profile from the user.

5. A method adapted for a robot, wherein the robot stores a set of predetermined motion output reactions, the method comprising:
initiate an input configuration program;
fetching a motion output reaction and performing a corresponding motion;
generating prompt information;
receiving a vocal input command from a user;
analyzing a digital vocal signal of the vocal input command to obtain a vocal input profile, and storing the vocal input profile; and
establishing a relationship between the motion output reaction and the vocal input profile, and storing the relationship.

6. The method as recited in claim 5, further comprising:
receiving a vocal input command out of the input configuration program;
obtaining a vocal input profile of the vocal input command;
comparing the vocal input profile with stored vocal input profiles; and
fetching a motion output reaction associated with the vocal input profile when existing for a relationship between the motion output reaction and the vocal input profile, and performing a corresponding motion.

7. The method as recited in claim 6, further comprising: performing specific information if not existing for the relationship.
